(19) United States
(12) Patent Application Publication
(10) Pub. No.: US 2005/0204632 A1
(43) Pub. Date: Sep. 22, 2005

(54) Door system opening on both the left and right sides

(76) Inventor: Takuji Minami, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 11/135,338

(22) Filed: May 24, 2005

Related U.S. Application Data
(62) Division of application No. 10/377,819, filed on Mar. 4, 2003.

(51) Int. Cl. E05D 7/02

(52) U.S. Cl. 49/382

(57) ABSTRACT

To provide a door opening on both the left and right sides which is easy to manufacture and operate and can be opened and closed accurately from either the left or right side. The present invention includes an inner door mounted in such a way that the door covers the open surface of the closet body to be opened/closed through hinges, and an outer door disposed on the outside of this inner door and mounted in such a way as to be opened/closed through hinges against the inner door. The door system is constructed in such a way that the inner and outer doors are opened and closed in different directions.

This application is a divisional of U.S. application Ser. No. 10/377,819, filed Mar. 4, 2003.

### BACKGROUND OF THE INVENTION

The present invention concerns a door system opening on both the left and right sides. More specifically, the invention concerns a door system opening on both the left and right sides in such a way that the door of a closet mounted either above a washstand or on a wall face may be opened and closed from either the left or right side to facilitate introduction and removal of the articles to be stored in the closet and to also enable to use mirrors mounted on the door as if they were mirrors mounted on a dressing table.

Conventionally, as a door system opening on both the left and right sides, there is one which is applied to a refrigerator door.

This door system opening on both the left and right sides is constructed by mounting special hinges at the top and the bottom edges on both the left and right sides for connection with the main body, in a way so that the door can be opened and closed from either the left or right side during its use.

By the way, in the conventional door system opening on both the left and right sides, while the door can be opened and closed from either the left or right side, a manufacturing or execution error is liable to be produced in a case in which a closet is mounted above a washstand or formed in a way to be embedded in a wall face, and the main body of a refrigerator, etc. manufactured with high accuracy is a solid box. In such a case, even if the members such as hinges, etc. for doors opening on both the left and right sides are manufactured with high accuracy, it becomes difficult to smoothly open/close the hinges of a door opening on both the left and right sides of which is requested high accuracy, should a manufacturing or execution error be produced on the main body.

### SUMMARY OF THE INVENTION

The objective of the present invention, realized in view of the problem with conventional door systems opening on both the left and right sides, is to provide a door opening on both the left and right sides which is easy to manufacture and operate and which can be opened and closed accurately from either the left or right side, even in cases where manufacturing or execution error occurs, provided that error is kept within a previously set range of tolerance.

To achieve this objective, the door system opening on both the left and right sides according to the present invention is characterized in that it is comprised of an inner door mounted in such a way that it covers the open surface of the closet body to be opened/closed through hinges, and an outer door disposed on the outside of this inner door and mounted in such a way as to be opened/closed through hinges against the inner door. The door system is constructed in such a way that the inner and outer doors are opened and closed in directions different from each other.

This door system opening on both the left and right sides can be realized in such a way that one door can be opened on the left side and the other door opened on the right side. The door system can also be simplified in construction by disposing a double door comprising an inner door and an outer door, arranged in such a way as to cover the open surface of the closet body on different (opposite) sides by dispersing the hinge mounting position of the inner door and the outer door to the left and right. This facilitates execution and makes it possible to provide a door system opening on both the left and right sides fit for general usage that features the smooth opening/closing of the respective doors.

In such a case, the inner door may be constructed of a sheet material. This makes it possible to have a different opening and closing direction for the outer door, and to cover the open surface of the closet body with the inner door in a state in which the outer door is open. Moreover, the inner door may be constructed with a frame having a window hole at the center.

This makes it possible to introduce and remove goods from the closet by simply opening the outer door, with improved operability. Furthermore, the hinges may be disposed at the top and bottom edges of the inner and outer doors. This simplifies the mounting of the inner and outer doors, enabling smooth opening/closing of the doors and providing a better look for the hinge mounting portion. Additionally, the inner and outer doors provided on both the left and right sides of the closet body disposed at the center may be constructed in opening/closing directions opposite each other on the left and the right sides. This enables the use of the closet body as a dressing table surmounted by mirrors, simply improving the commercial value of the closet.

### BRIEF DESCRIPTION OF THE DRAWINGS

FIG. 1 is an explanatory drawing of the opening/closing motion of the door system, showing an embodiment of the door system opening on both the left and right sides according to the present invention, in which FIG. 1(A) is a plan view showing closed state, FIG. 1(B) a plan view showing a state in which the outer door is open, and FIG. 1(C) is a plan view showing a state in which the inner door is opened along the outer door.

FIG. 2 is a plan view with an expanded hinge portion for explaining the opening/closing motion, in which FIG. 2(A) shows a closed state, FIG. 2(B) shows a state in which the outer door is opened, and FIG. 2(C) shows a state in which the inner door is opened along the outer door, respectively.

FIG. 3 shows the mounted state of hinges, in which FIG. 3(A) is a front elevation of the bottom part of the inner door, FIG. 3(B) is a plan view, FIG. 3(C) is a front elevation of the top part of the inner door, FIG. 3(D) is a left end face view, and FIG. 3(E) a right end face view.

FIG. 4 is a perspective view of the appearance of hinges, in which FIG. 4(A) shows a hinge for mounting an inner door, FIG. 4(B) is a different embodiment of a hinge for mounting an inner door, and FIG. 4(C) shows a hinge for mounting an outer door, respectively.

FIG. 5 shows an embodiment in which the washing unit is realized in the form of a dressing table surmounted by mirrors, in which FIG. 5(A) is a front elevation, and FIG. 5(B) is a plan view.

FIG. 6 is a front elevation of a state in which the left is open and the right door is closed.

FIG. 7 is a plan view showing an example of use with the doors open.

### DETAILED DESCRIPTION OF THE INVENTION

Embodiments of the door system opening on both the left and right sides according to the present invention will be explained below based on drawings.

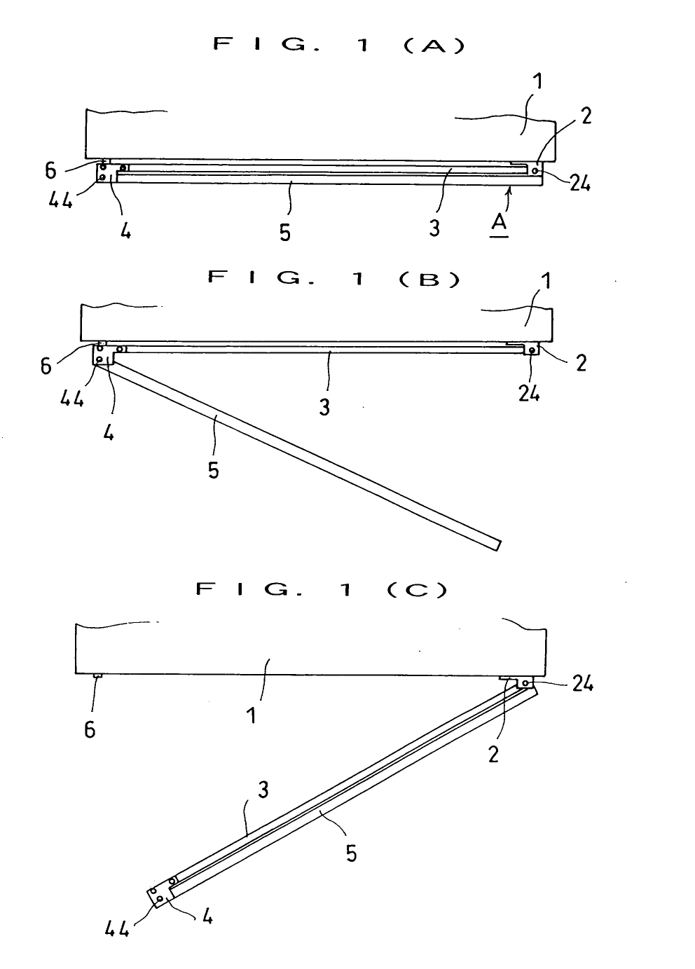

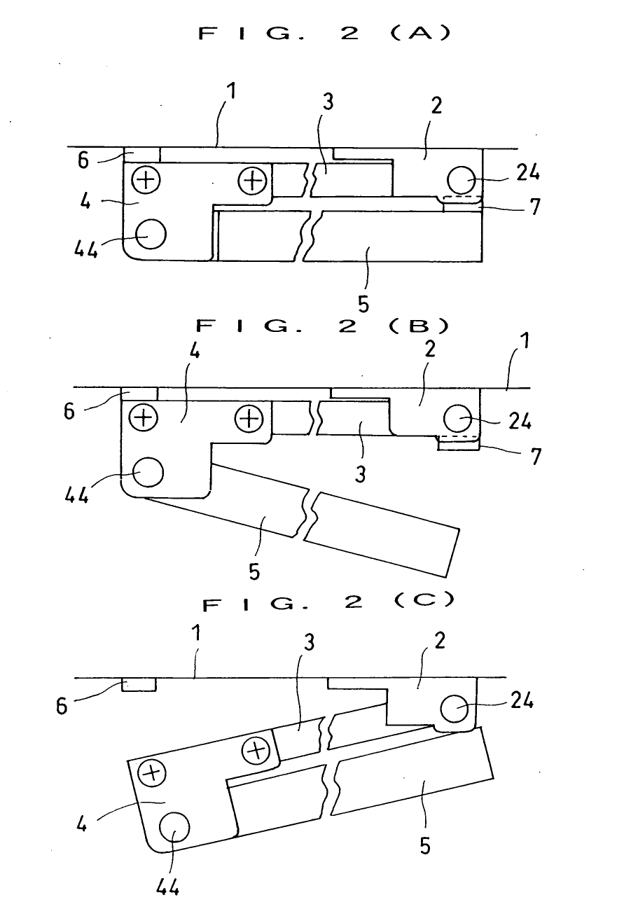

FIG. 1 to FIG. 6 illustrate an embodiment in which the door system opening on both the left and right sides according to the present invention is applied to a closet (washing unit) either formed above a washstand or disposed on a wall face.

The door system A opening on both the left and right sides according to the present invention is constructed with an inner door 3 mounted in a way so as to be opened/closed through a first hinge 2 mounted at the end on either the left or right sides (right end in the embodiment in FIG. 1) of the closet body 1 either formed above a washstand or disposed on a wall face. An outer door 5 is mounted on this inner door 3 in a way so as to be opened/closed through second hinge 4 mounted at the end part (left end in the embodiment in FIG. 1) on the side opposite to the mounting position of the first hinge 2.

In that case, to prevent any unnecessary opening/closing of the inner door 3 and the outer door 5, between the closet body 1 and the inner door 3 and also between the inner door 3 and the outer door 5 are mounted fastening devices respectively, such as magnet type fasteners 6, 7 composed of a magnet and an exciter panel, for example, though not particularly restricted to such construction.

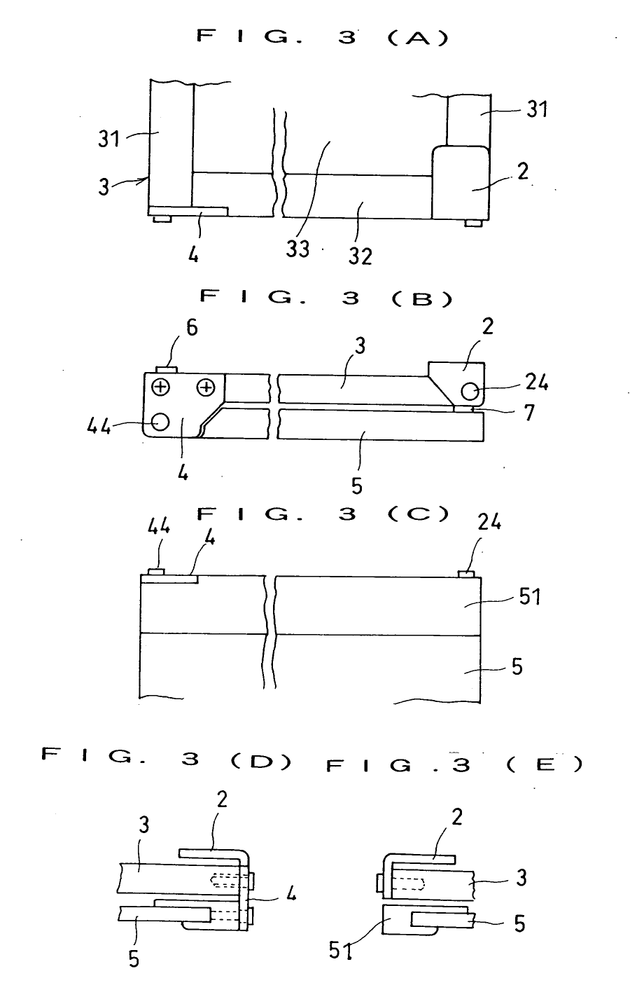

The mounting position of these magnet fasteners 6, 7 is not particularly restricted, if only the two fasteners are disposed in positions opposite to each other, as shown in FIG. 3. The first magnet fastener 6 mounted between the closet body 1 and the inner door 3 may be disposed, though not particularly restricted, on the closet body 1 at an end of inner door 3 opposite to the first hinge 2, and the second magnet fastener 7 mounted between the inner door 3 and the outer door 5 may be disposed on the inner door 3 at an end of the outer door 5 opposite to the second hinge 4, for example.

Moreover, a permanent magnet will be used for the magnet of these magnet fasteners 6, 7, while an exciting metal sheet piece will be used for the exciter panel (not illustrated) which mutually adsorbs with (attracts) the magnet. However, the exciter panel may be omitted in the case in which the inner door 3 and the outer door 5 are made of an exciting material at least at the portion facing the magnet.

The first hinge 2 and the second hinge 4 will be constructed with the same function, though not particularly restricted to such construction, and the first hinge 2 and the hinge 4 shall preferably be disposed at the top and the bottom ends of the inner door 3 and the outer door 5, respectively, to thereby enable the inner door 3 and the outer door 5 to open/close in opposite directions.

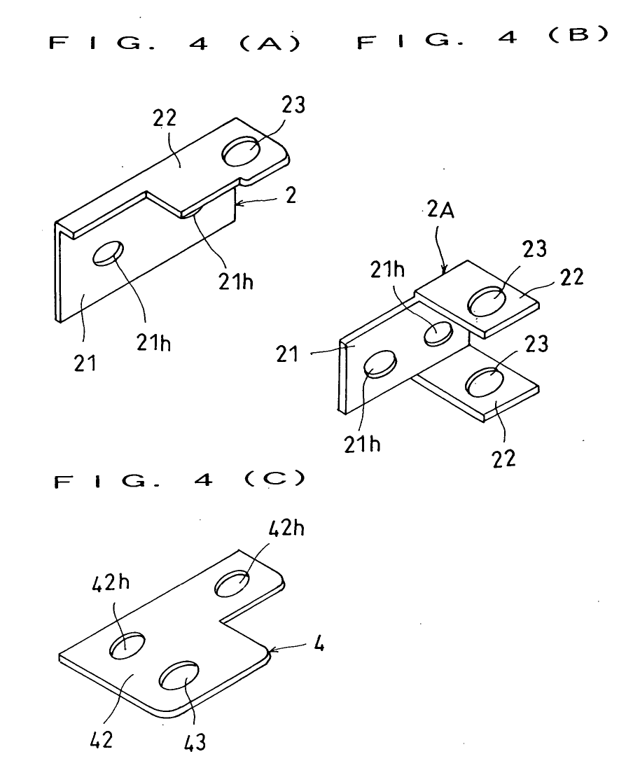

This first hinge 2, having an L-shaped section as shown in FIG. 4(A), is composed of a mounting piece 21 in which is formed a screw hole 21h so that this piece may be screwed to the closet body 1 side, and a hinge piece 22 bent to extend from the mounting piece 21 and still be connected to it to form an L shape, and in this hinge piece 22 is formed a shaft hole 23. A pair of these hinge pieces 22 are disposed in such a way as to face each other at the top and the bottom of the inner door 3, and a screw shaft 24 inserted in each shaft hole 23 is screwed in the top and the bottom end faces of the inner door 3, so that the inner door 3 may be mounted in a way to open and close the closet body 1.

Furthermore, the first hinge 2A indicated in FIG. 4(B) is a modified example of first hinge 2, realized by disposing bent hinge pieces 22, 22 facing each other at the top and the bottom on one side of the mounting piece 21 in which are formed screw holes 21h, 21h, and pierced shaft holes 23, 23 in these hinge pieces 22, 22, respectively, to be used in a way to hold the frame of the inner door 3 at the top and the bottom.

Still more, the second hinge 4 is constructed by forming, in a flat hinge piece 42 provided so as to face the top or the bottom faces of the inner door 3, screw holes 42h, 42h formed in a way to fix each second hinge 4 by screwing to the inner door 3, and a shaft hole 43 realized in a way to support a shaft at the top and the bottom faces of the outer door 5, as shown in FIG. 4(C). Thus, the outer door 5 can be mounted on the inner door 3 in a way to open and close, by screwing a screw shaft 44 into the shaft hole 43 at the top and the bottom end faces of the outer door 5.

Yet more, the inner door 3 and the outer door 5 shall have a size and shape at least sufficient for covering the entire surface of the opening in the closet body 1 and, while the material of the inner door 3 is not particularly restricted, the outer door 5 may be provided with a mirror on the surface, to be used as a mirror in the same way as the door of a conventional closet provided above a washstand.

In the case where the closet is disposed on the left and the right from right above the washstand, this mirror door of the closet disposed above the washstand may be used as a dressing table with mirrors, in combination with the outer doors 5, 5 of the closet provided in the transversal direction.

The inner door 3 and outer door 5 may be constructed in the same way as conventional doors, with no particular restriction, if only they look all right when disposed above a washstand.

By constructing the inner door 3 with a sheet material in the same way as an ordinary door, it becomes possible to open/close the outer door 5 in different directions or, to be concrete, change the opening/closing direction of the outer door 5 depending on whether the opening of the closet body 1 is left open or if the door with mirror of the closet is used as a dressing table with mirrors, in combination with the outer doors 5, 5 of the closet. It further becomes possible, in the case where the outer doors 5, 5 are used as a dressing table with mirrors, to cover the entire surface of the opening in the closet body 1 with the inner door 3, even if the outer door 5 is left in an open state.

Moreover, the inner door 3 may also be formed as a frame pierced by a window hole (i.e., a through-hole) 33 at the central part surrounded by a longitudinal frame 31 and a transversal frame 32, as shown in FIG. 3(A). This makes it possible to introduce and take out goods easily in and from the closet through this window hole 33 in the inner door 3, in a state in which the outer door 5 is left open, without creating any obstacle to the use of the closet because this window hole 33 in the inner door 3 is also closed by closing the outer door 5.

Furthermore, in the case where the outer door 5 is a mirror board, it will be provided with frame materials 51, 51 disposed at the top and the bottom ends of the mirror board in a way to hold the mirror in the transversal direction, and a second hinge 4 will be mounted at the end of this frame material 51, as shown in FIG. 3.

The hinges 2, 4, for which different constructions are adopted in the embodiment indicated in FIG. 4, may also be constructed in the same way.

Next, an explanation will be made on the motions of this door system opening on both the left and right sides.

On the closet body 1 is mounted the inner door 3 through the first hinge 2 and the shaft 24, and on this inner door 3 is mounted the outer door 5 through the second hinge 4 and the shaft 44 respectively so that the door 3, 5 can be opened/closed individually. As a result, the door covering the opening of the closet body 1 becomes a double door comprising an inner door and an outer door.

When goods are either introduced in the closet body 1 or taken out from it, the opening of the closet body 1 is released, as the inner door 3 is opened through the hinge 2, allowing introduction of goods into or removal of goods from inside the closet freely.

Yet more, when the outer door 5, on the surface of which is mounted a mirror, is opened, the opening of the outer door 5 is made through the second hinge 4 in a way to release the adsorption (attraction) by the magnet fastener 7, in a state in which the inner door 3 mounted on the closet body 1 is fastened with the magnet fastener 6. The degree of opening of the outer door 5 is adjustable. At that time, by forming the inner door 3 with a frame in which is drilled a window hole (through-hole) at the central part, it becomes possible to introduce goods into or remove them from inside the closet by opening the outer door 5. If the inner door 3 and the outer door 5 are closed, their closed state is maintained by an adsorptive action (attraction) of the magnet fasteners 6, 7 respectively.

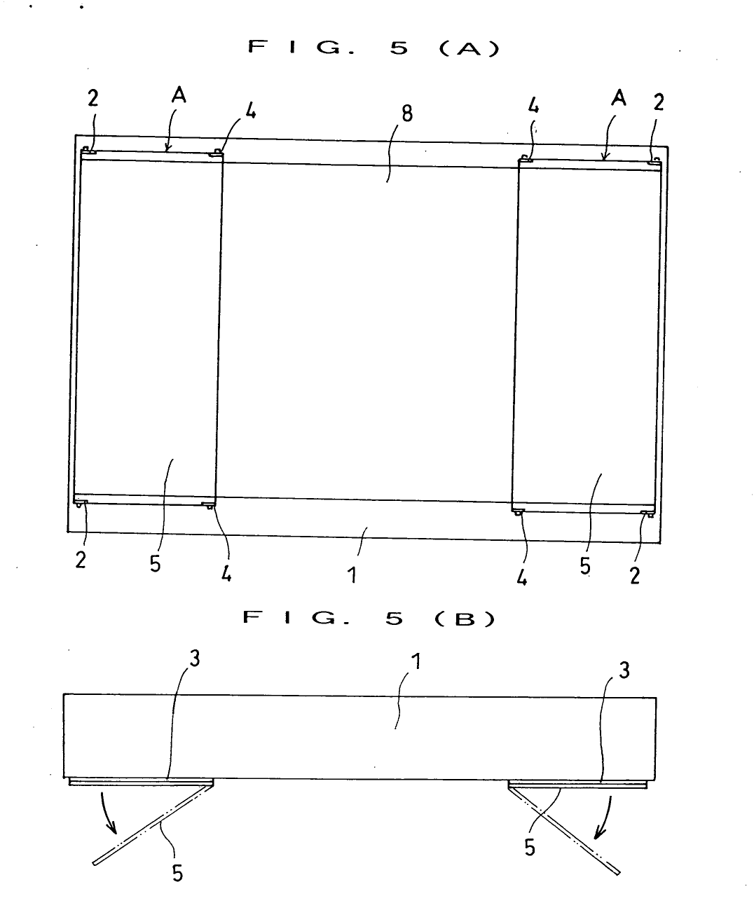

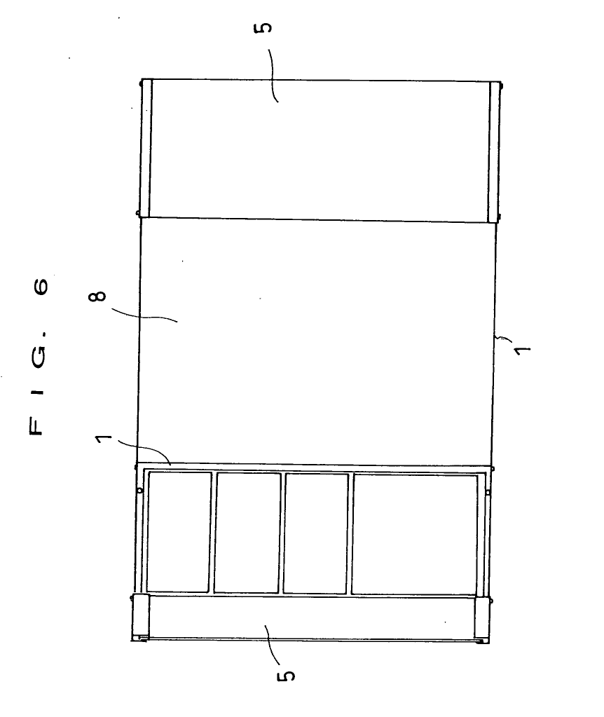

In the case where the door system is used as a dressing table with mirrors, a mirror board 8 will be mounted at the central part of the closet body 1, either fixed or in a way to be opened and closed. At both the left and right end parts of this closet body 1 will be disposed door systems A, A opening on both the left and the right sides of the construction, as shown in FIG. 5 and FIG. 6.

In that case, the mounting position of the first hinge 2 connecting the closet body 1 and the inner door 3 to each other will be disposed at different positions (symmetrical positions) for the left and right storing areas, for example. In the embodiment indicated in FIG. 5, while the mounting position of the first hinge 2 connecting the closet body 1 and the inner door 3 to each other will be disposed at the outside position of the closet body 1 respectively, the mounting position of the first hinge 2 is not particularly restricted to this position, and may also be disposed on the inside position of the closet body 1 (position on the mirror board 8 side at the central part). The mounting position of the first hinge 2 may further be disposed in the same direction at the left and right storing areas (one hinge 2 at the outside position of the closet body 1, and the other hinge 2 at the inside position of the closet Body 1). As a result, as the left and right outer doors 5, 5 are opened, the surface side of the left and right outer doors 5, 5 mutually turns inside at a certain angle respectively, as shown in FIG. 5(B).

This makes it possible to use the outer door 5, on the surface of which is disposed a mirror, as dressing table with mirrors.

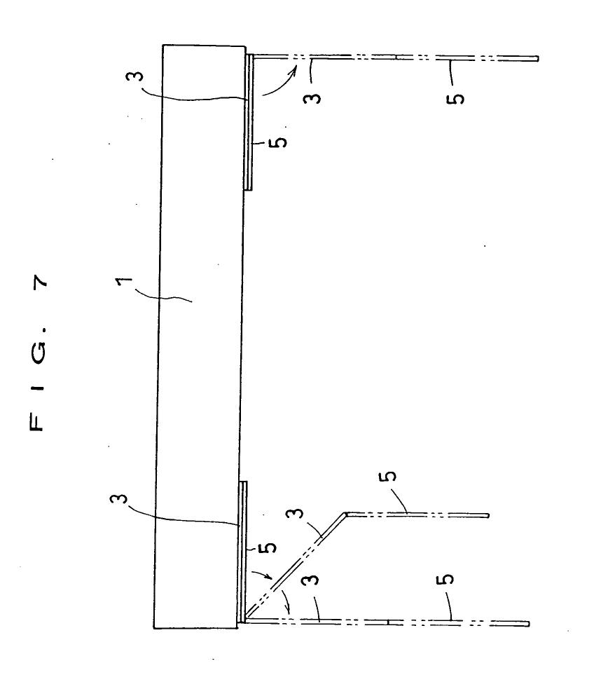

By disposing the mounting position of the hinge 2 connecting the closet body 1 and the inner door 3 to each other at the outside position of the closet body 1 respectively, as shown in the embodiment indicated in FIG. 5, it becomes possible to open the inner door 3 and the outer door 5 up to a position where they become almost linear, as shown in FIG. 7, for example. This enables the outer door 5, on the surface of which is disposed a mirror, to protrude to the front face of the closet body 1 in the state in which the mirrors look inward. Thus, a person who stands in the front face of the closet body 1 can use the mirror on the outer door 5 at the closest position, and can perform fitting of contact lenses smoothly, for example.

An explanation has so far been provided for the door system opening on both the left and right sides according to the present invention based on an embodiment applied to a closet (washing unit) disposed above a washstand. However, the present invention is not restricted to the construction indicated in this embodiment, and can also be applied widely to doors of a closet formed in a way to be embedded in a wall face, and its construction can be changed as desired within a range not deviating from its purpose, depending on the object of application.

1. A dressing table comprising:
a closet body; and
a door system mounted to said closet body, said door system including:
an inner door mounted by a first hinge to said closet body so as to cover an opening of said closet body, said inner door being operable to swing open and closed via said first hinge, said inner door including a frame and a central window through-hole in said frame; and
an outer door mounted by a second hinge to an outer side of said inner door so as to cover said central window through-hole of said inner door, said outer door being operable to swing open and closed via said second hinge, said first hinge and said second hinge being located on opposite sides of said door system so that said inner door and said outer door are swung in different directions so as to be opened and closed

2. The dressing table of claim 1, wherein said door system comprises a first door system located at a left side of said closet body, further comprising a second door system located at a right side of said closet body, said second door system including:
an inner door mounted by a first hinge to said closet body so as to cover an opening of said closet body, said inner door being operable to swing open and closed via said first hinge, said inner door including a frame and a central window through-hole in said frame; and
an outer door mounted by a second hinge to an outer side of said inner door so as to cover said central window through-hole of said inner door, said outer door being operable to swing open and closed via said second hinge, said first hinge and said second hinge being located on opposite sides of said door system so that said inner door and said outer door are swung in different directions so as to be opened and closed;
wherein said first door system and said second door system are arranged so as to swing open and closed in directions opposite to each other.

3. The dressing table of claim 2, wherein said inner door of each of said first door system and said second door system is formed of a sheet material.

4. The dressing table of claim 2, wherein said first hinge of each of said first door system and said second door system comprises a first upper hinge located at a top edge of said inner door and a first lower hinge located at a bottom edge of said inner door, said second hinge of each of said first door system and said second door system comprising a second upper hinge located at a top edge of said outer door and a second lower hinge located at a bottom edge of said outer door.

5. The dressing table of claim 2, wherein said first hinge of each of said first door system and said second door system is located at a first end of said inner door, and said second hinge of each of said first door system and said second door system is located at a first end of said outer door, each of said first door system and said second door system further including a first magnet fastener located at a second end of said inner door opposite said first end of said inner door so as to keep said inner door closed, and a second magnet fastener located at a second end of said outer door opposite said first end of said outer door so as to keep said outer door closed.

6. The dressing table of claim 5, wherein said first magnet fastener of each of said first door system and said second door system is mounted on said closet body, and said second magnet fastener is mounted on said inner door.

7. The dressing table of claim 2, wherein each of said first door system and said second door system further includes a mirror mounted on an outer surface of said outer door.
